(19) United States
(12) Patent Application Publication
(10) Pub. No.: US 2009/0225378 A1
(43) Pub. Date: Sep. 10, 2009

(54) IMAGE PROCESSING APPARATUS, ORIGINAL DOCUMENT SCANNING APPARATUS, AND COLOR/MONOCHROME DETERMINING METHOD

(75) Inventor: Katsushi MINAMINO, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/358,369

(22) Filed: Jan. 23, 2009

(30) Foreign Application Priority Data
Mar. 4, 2008 (JP) 2008-053693

(51) Int. Cl. H04N 1/46; G06K 9/00

(52) U.S. Cl. 358/513; 382/165

(57) ABSTRACT

An image processing apparatus including a data analyzing unit includes an input unit and a color/monochrome determining unit. The input unit inputs image data that is obtained by scanning an original document through a CCD having a plurality of lines that can scan color documents. The color/monochrome determining unit determines whether the original document is color or monochrome based on the input image data. When chromatic pixels and their complementary color pixels are detected in a specified image area of the image data, the color/monochrome determining unit excludes the detected chromatic pixels and their complementary color pixels from information that is used in the determination in which the original document of the image data is determined as color or monochrome.

### CROSS-REFERENCE TO RELATED APPLICATIONS

This application claims priority under 35 U.S.C. 119 to Japanese Patent Application No. 2008-053693, filed on Mar. 4, 2008, which application is hereby incorporated by reference in its entirety.

### BACKGROUND OF THE INVENTION

1. Field of the Invention

The present invention primarily relates to an image processing apparatus that can determine whether a scanned original document is a color document or a monochrome document based on image data obtained by scanning the original document.

2. Description of the Related Art

An original document scanning apparatus that scans an original document by moving an original document scan position relative to the original document is known. Image displacement may occur in scanned image data in the original document scanning apparatus. Here, image displacement refers to displacement (for example, skew) that occurs in the generated image data when a relative movement speed of the original document and the original document scan position changes locally. The image displacement especially tends to occur when the original document is transported through an Auto Document Feeder (ADF). This is because a transportation speed of the original document tends to change locally when the original document is transferred among a plurality of transportation rollers of the ADF or when the original document instantaneously makes contact with a guide wall, for example, arranged on an original document transportation path, for example.

Further, an original document scanning apparatus that uses a 3-line Charge Coupled Device (CCD) as an image sensor and that can scan both a monochrome document and a color document is known. The 3-line CCD includes three lines that correspond to three primary colors (Red, Green, and Blue: RGB) and scans the color document by separating, into three color components, light that is reflected from the original document to which white light is radiated.

Furthermore, in an original document scanning apparatus that can scan both a monochrome document and a color document, a configuration including a function of automatically determining whether the scanned original document is a color document or a monochrome document is known. The color/monochrome determination can be made by, for example, counting the number of color pixels (chromatic pixels) of scanned image data, and then checking whether or not the counted value exceeds a prescribed threshold value.

In the 3-line CCD, the lines arranged to scan the respective color components are disposed at positions that are different from one another. Accordingly, each line scans a different position of the original document at the same time.

When data of each color component is temporarily accumulated in a memory, and then combined to generate image data, the scan position displacement (difference) can be corrected by delaying a reading-out operation by the number of lines that corresponds to a gap occurred between the lines (line gap correction). However, when the image displacement occurs because of the local change in a scanning speed as described above, as a result of the line gap correction, an image having mismatched positions of the three color components at a portion where the image displacement occurred is formed. Such displacement of the three color components will be hereinafter referred to as a “color shift”.

Accordingly, in a monochrome original document, for example, if the scanning speed changes when a boundary of black and white in a character is being scanned, a chromatic color (false color) is generated at the boundary portion based on the image displacement in the image data on which the line gap correction has been performed. As a result, the monochrome document may be erroneously determined as being a color document in the color/monochrome determination of the original document.

In view of the above-described problem, in order to accurately identify a color of the original document (including color documents and monochrome documents), a known image processing apparatus changes, with respect to an area in which a colored line tends to be generated, conditions that are used in the color/monochrome determination, and uses a chromatic color determination threshold value that is different from that of other areas. The colored line arises from adverse effects of the change in the original document transportation speed on the line gap correction.

Thus, by changing the determination threshold value with respect to each area of the original document, the accuracy of the color/monochrome identification is improved to some extent, however, it is difficult to prevent erroneous determinations in which the monochrome document is determined as a color document when a number of colored pixels are generated due to false colors, for example. Moreover, it is also difficult to accurately predict an amount of false color generation. Therefore, the erroneous determinations in which a color document is determined as a monochrome document may be made depending on the settings of the threshold value. Accordingly, it has been desired to improve the accuracy of the determinations.

### SUMMARY OF THE INVENTION

In order to overcome the problems described above, preferred embodiments of the present invention provide an image processing apparatus that can effectively avoid effects of false colors and make color/monochrome determinations of an original document more accurately.

The problems to be solved by the present invention have been described. The methods to solve the problems and their advantages will now be described.

According to a preferred embodiment of the present invention, an image processing apparatus includes an input unit and a color/monochrome determining unit. The input unit is arranged to input image data that is obtained by scanning an original document through a sensor having a plurality of lines that can scan color documents. The color/monochrome determining unit is arranged to determine whether the original document or a portion of the original document is color or monochrome based on the image data that is input through the input unit. The color/monochrome determining unit includes a hue determining unit arranged to determine a hue of each pixel of the image data. As a result of the determination made by the hue determining unit, when a chromatic pixel and its complementary color pixel are detected in a color shift expected area, which is a specified image area of the image data, the color/monochrome determining unit makes the color/monochrome determination with respect to the color shift expected area under conditions differing from that of other image areas.

In other words, in the color/monochrome determination of the original document, even when the chromatic pixels are detected in the image data, such chromatic pixels are likely to be false colors if the chromatic pixels are detected along with their complementary color pixels in the specified image area (color shift expected area), in which image displacement tends to occur. In view of this point, in the above-described configuration, when the chromatic pixels and their complementary color pixels are detected in the color shift expected area, the color/monochrome determination is made under the conditions differing from that of the other image areas than the color shift expected area. Therefore, erroneous determinations in which a monochrome document is determined as a color document because of the generation of the false colors can be effectively prevented. Further, in a method of simply determining pixels as chromatic or achromatic, erroneous determinations in which a color document is determined as a monochrome document may be made under more strict determination conditions, however, in the above-described configuration, it is not necessary to determine the other areas than the color shift expected area under strict determination conditions, which can thereby prevent erroneous determinations.

In the image processing apparatus of the present preferred embodiment, it is preferable that the chromatic pixels and their complementary color pixels detected in the color shift expected area are excluded from information that is used in the color/monochrome determination made by the color/monochrome determining unit.

Thus, a pixel with a high possibility of having a false color arising from image displacement can be excluded from information that is used in the color/monochrome determination. Accordingly, the erroneous determinations in which the monochrome document is determined as a color document can be prevented.

In the image processing apparatus of the present preferred embodiment, the hue determining unit is preferably arranged to determine which hue area, which is set by dividing a color space into a plurality of areas in hue directions, the detected chromatic pixel belongs to. The color/monochrome determining unit preferably includes an each-hue-area counting unit, an each-hue-area-color determining unit, and a determining unit. The each-hue-area counting unit preferably counts, with respect to each hue area, the number of pixels that have been determined to belong to the corresponding hue area. The each-hue-area-color determining unit preferably compares, with respect to each hue area, the counted number of pixels with a prescribed threshold value, and then determines that there is a color of the corresponding hue area when the counted number of pixels exceeds the threshold value. The each-hue-area counting unit and the each-hue-area-color determining unit counts the number of pixels and determines the existence of the color with respect to each image area, which is set by dividing the image data into a plurality of areas. The determining unit preferably determines whether the original document of the image data or a portion of the original document is color or monochrome. When the each-hue-area-color determining unit determines that there is a color in at least two hue areas with respect to the image area that is included in the color shift expected area, and further, only when each hue area is a pair of hue areas that are in a complementary-color relationship with each other, the determining unit excludes each pixel that is in the image area and that has been determined to belong to any of the pair of hue areas from the information that is used in the color/monochrome determination.

In the above-described configuration, when both a color of a hue area and a color of its complementary color hue area are determined to exist with respect to the color shift expected area of the divided image areas, the pixels of the image area and the pixels of the hue area can be properly excluded from the information that is used in the determination. As a result, the erroneous determinations of color/monochrome original documents can be prevented. Further, by counting the number of pixels with respect to each hue area, the information indicating the hue area in which the chromatic color is detected can be acquired and used in the determination. Thus, a chromatic color that arises from a false color and a chromatic color of a color original document can be effectively distinguished from one another and determined.

In the image processing apparatus of the present preferred embodiment, when a difference between the number of chromatic pixels and the number of their complementary color pixels detected in the color shift expected area falls below a prescribed value, it is preferable that the color/monochrome determining unit excludes the detected chromatic pixels and their complementary color pixels from the information that is used in the determination.

In the above-described configuration, in view of the tendency that the number of chromatic pixels and the number of their complementary color pixels both arising from the image displacement do not differ greatly from one another, the color/monochrome determination of the original document can be made more appropriately.

In the image processing apparatus of the present preferred embodiment, when the number of detected chromatic pixels falls below a threshold value that is determined based on the number of black pixels in the color shift expected area, it is preferable that the color/monochrome determining unit excludes the detected chromatic pixels and their complementary color pixels from the information that is used in the determination.

When the false colors (chromatic color and its complementary color) arising from the image displacement are generated at a boundary of a black portion of the monochrome original document, it is highly likely that the number of chromatic pixels that are positioned adjacent to one side of the black portion falls below the number of black pixels. Therefore, by counting the black pixels as well as the chromatic pixels, and by comparing the number of chromatic pixels with the threshold value that is determined based on the number of black pixels as described above, the color/monochrome determination of the original document can be more accurately made. Moreover, the determination can be made by performing a simple counting process, and accordingly, the processes can be easily performed at high speed.

In the image processing apparatus of the present preferred embodiment, when the chromatic pixels are positioned adjacent to one side of the black pixels in the color shift expected area, and the corresponding complementary color pixels are positioned adjacent to the other side of the black pixels in the color shift expected area, it is preferable that the color/monochrome determining unit excludes the detected chromatic pixels and their complementary color pixels from the information that is used in the determination.

In the above-described configuration, in view of the fact that the chromatic pixels and their complementary color pixels as the false colors arising from the image displacement are detected at the positions that adjacently sandwich the black pixels, the color/monochrome determination of the original document can be more accurately made.

In the image processing apparatus of the present preferred embodiment, the color/monochrome determining unit preferably selects one of a first mode or a second mode. In the first mode, in the color/monochrome determination of the original document of the image data, the chromatic pixels and their complementary color pixels detected in the color shift expected area are excluded from the information that is used in the determination. In the second mode, the chromatic pixels and their complementary color pixels detected in the color shift expected area are included in the information that is used in the determination.

In the above-described configuration, by changing a color/monochrome determining method in accordance with a situation, the determination can be appropriately made.

In the image processing apparatus of the present preferred embodiment, the input unit can input image data of a test chart that is obtained by scanning a test chart original document through the sensor. By analyzing the test chart image data, the color/monochrome determining unit can set the color shift expected area.

In the above-described configuration, even if the image area in which the color shift tends to be generated differs depending on an individual difference of an image scanning apparatus, or the like, by analyzing the test chart image data, the color shift expected area can be properly set. Accordingly, the color/monochrome determination of the original document can be accurately made.

In the image processing apparatus of the present preferred embodiment, it is preferable that the color/monochrome determining unit can change the color shift expected area in accordance with a type of a medium of the original document.

In the above-described configuration, even when the image area in which the false color tends to be generated changes in accordance with the type of the medium of the original document, the color/monochrome determination can be accurately made.

Another preferred embodiment of the present invention provides an original document scanning apparatus including an original document scanning unit arranged to scan an original document through a CCD sensor having a plurality of lines that can scan color documents, an ADF, and the image processing apparatus.

In the above-described original document scanning apparatus, even when a false color arising from image displacement is generated in image data that is obtained by scanning a monochrome original document through the CCD sensor of the original document scanning unit, erroneous determinations in which the monochrome document is determined as a color document can be prevented. Moreover, because the false color arising from the image displacement tends to be generated in a specified image area when the original document is transported and scanned through the ADF, it is particularly preferable to use the present invention.

It is preferable that the original document scanning apparatus of the present preferred embodiment can also scan the color original document by using a flatbed method. When the original document is transported and scanned through the ADF, the color/monochrome determining unit of the image processing apparatus excludes the chromatic pixels and their complementary color pixels that are detected in the color shift expected area from the information that is used in the color/monochrome determination of the original document. Further, when the original document is scanned in the flatbed method, it is preferable that the chromatic pixels and their complementary color pixels that are detected in the color shift expected area are included in the information that is used in the color/monochrome determination of the original document.

In other words, when the original document is scanned in the flatbed method, the color shift occurs less than when compared with the case in which the original document is transported and scanned through the ADF. Therefore, by not performing the process of preventing the color/monochrome erroneous determinations when scanning the original document in the flatbed method, the processes can be effectively performed.

It is preferable that the original document scanning apparatus of the present preferred embodiment can scan the color original document also in the flatbed method, and that the image processing apparatus can store the different color shift expected areas and select the color shift expected area that is used when transporting and scanning the original document through the ADF or the color shift expected area that is used when scanning the original document in the flatbed method.

In other words, because the area in which the image displacement tends to occur differs when the original document is transported and scanned through the ADF and when the original document is scanned in the flatbed method, by enabling to select the area, any method of scanning the original document can be properly handled.

Another preferred embodiment of the present invention provides a test chart that has boundaries of a light color and a deep color in a sub scanning direction in an entire area except for a margin and that is scanned through the original document scanning apparatus.

By scanning the test chart through the original document scanning apparatus, the color shift is reliably generated in the area in which the color shift likely occurs, and thus, the area can be specified.

Another preferred embodiment of the present invention further provides a color/monochrome determining method that is used to determine whether an original document or a portion of the original document is color or monochrome based on image data that is obtained by scanning the original document through a sensor having a plurality of lines that can scan color documents. When chromatic colors each having an opposite hue are detected on the respective sides of black pixels in a color shift expected area, which is a specified image area of the image data, the determination is made with respect to the color shift expected area under conditions differing from that of other areas.

In the above-described method, the color shift arising from the image displacement can be reliably detected, and thus, the color/monochrome erroneous determinations of the original document can be prevented.

In the above-described color/monochrome determining method, it is preferable that the chromatic pixels are excluded from information that is used in the determination.

In the above-described method, information about the pixels with a high possibility of having the false color arising from the image displacement can be excluded from the information that is used in the color/monochrome determination, which thereby improves the accuracy of the determination.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a front sectional view illustrating an overall configuration of an image scanner apparatus according to a preferred embodiment of the present invention.

FIG. 2 is a block diagram illustrating an electrical configuration of the image scanner apparatus according to a preferred embodiment of the present invention.

FIG. 3 illustrates a situation where no displacement is generated among RGB components of a monochrome original document.

FIG. 4 illustrates a situation where displacement is generated in the R component of the monochrome original document.

FIG. 5 illustrates a situation where displacement is generated in the G component of the monochrome original document.

FIG. 6 illustrates a situation where displacement is generated in the B component of the monochrome original document.

FIG. 7 is a schematic diagram of hue areas on a hue plane.

FIG. 8 is a schematic diagram illustrating a situation where original document data is divided into prescribed blocks.

FIG. 9 is a flowchart of the first half of a color/monochrome determining process according to a preferred embodiment of the present invention.

FIG. 10 is a flowchart of the second half of the color/monochrome determining process.

FIG. 11 illustrates an example of a test chart original document according to a preferred embodiment of the present invention.

FIG. 12 is a schematic diagram illustrating a test chart image scanned from the test chart original document.

FIG. 13 is an enlarged view of an area “X” of FIG. 12, illustrating a state in which false colors are generated because of color displacement.

### DETAILED DESCRIPTION OF PREFERRED EMBODIMENTS

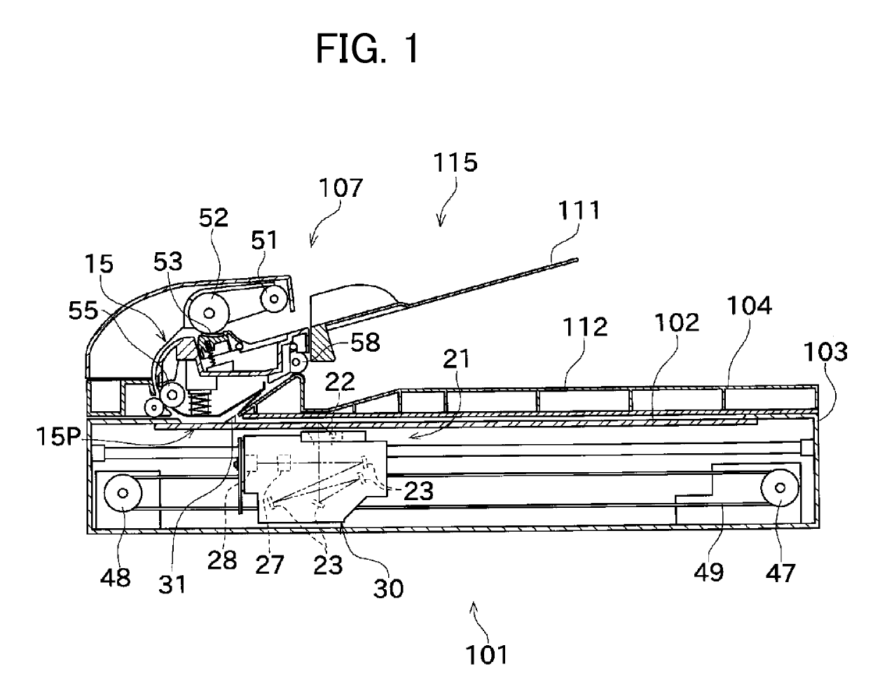

Preferred embodiments of the present invention will now be described with reference to the drawings. FIG. 1 is a front sectional view illustrating an overall configuration of an image scanner apparatus according to a preferred embodiment of the present invention.

As illustrated in FIG. 1, an image scanner apparatus 101 defining an original document scanning apparatus preferably includes an original document scanning unit 115 having an ADF unit and a flatbed unit.

More specifically, the image scanner apparatus 101 preferably includes an original document table 103 having a platen glass 102 on which an original document is placed, and an original document table cover 104 arranged to maintain the original document such that the original document is pressed against the platen glass 102. The image scanner apparatus 101 also includes an operation panel (not illustrated) to commence the start of the original document scanning, or other suitable operations.

The original document table cover 104 is preferably provided with an ADF 107. The ADF 107 preferably includes an original document tray 111 arranged on an upper portion of the original document table cover 104 and a discharge tray 112 arranged below the original document tray 111.

As illustrated in FIG. 1, a curved original document transportation path 15, which links the original document tray 111 to the discharge tray 112, is preferably arranged inside the original document table cover 104. The original document transportation path 15 preferably includes a pick up roller 51, a separation roller 52, a separation pad 53, a transportation roller 55, and a discharge roller 58.

The pick up roller 51 picks up the original document placed on the original document tray 111. The separation roller 52 and the separation pad 53 are arranged to separate picked up documents one sheet at a time. The transportation roller 55 is arranged to transport the separated original document towards an original document scan position 15P. The discharge roller 58 is arranged to discharge the scanned document onto the discharge tray 112.

In the above-described configuration, the original documents placed on the original document tray 111 are separated one sheet at a time. The separated original document is transported along the curved original document transportation path 15, passes through the original document scan position 15P, is scanned through a scanner unit 21 to be described later, and then has its path changed obliquely upward by a path guide 31 to be discharged onto the discharge tray 112.

As illustrated in FIG. 1, the scanner unit 21 is arranged inside the original document table 103. The scanner unit 21 preferably includes a carriage 30 that can be moved inside the original document table 103.

The carriage 30 includes a fluorescent lamp 22 arranged as a light source, a plurality of reflection mirrors 23, condenser lens 27, and a Charge Coupled Device (CCD) 28. The fluorescent lamp 22 radiates light to the original document. The reflected light from the original document is reflected by the plurality of reflection mirrors 23, passes through the condenser lens 27, converges, and forms an image on a surface of the CCD 28. The entered convergent light is converted into an electric signal and then output by the CCD 28.

According to a preferred embodiment of the present invention, a 3-line color CCD is preferably used as the CCD 28. The CCD 28 preferably includes an elongate one-dimensional line sensor with respect to each color of Red, Green, and Blue (RGB). Each of the line sensors substantially extends in a main scanning direction (i.e., a width direction of the original document). The CCD 28 also preferably includes different color filters that correspond to the respective line sensors.

A drive pulley 47 and a driven pulley 48 are preferably rotationally supported inside the original document table 103. An endless drive belt 49 is preferably arranged between the drive pulley 47 and the driven pulley 48 in a tensioned state. The carriage 30 is preferably fixed to a proper position of the drive belt 49. In the above-described configuration, by forwardly and reversely driving the drive pulley 47 by an electric motor (not illustrated), for example, the carriage 30 can travel horizontally along a sub scanning direction.

In the above-described configuration, when the carriage 30 is moved in advance to the original document scan position 15P, the ADF 107 is driven. Accordingly, the original document to be transported in the original document transportation path 15 is scanned at the original document scan position 15P. The reflection light, which is radiated from the fluorescent lamp 22 and reflected by the original document, is introduced into the carriage 30, directed to the CCD 28 by the reflection mirrors 23 via the condenser lens 27, to form an image. Thus, the CCD 28 can output an electric signal that corresponds to the scanned content.

When using a flatbed scanner, while the carriage 30 is moved at a prescribed speed along the platen glass 102, an original document placed on the platen glass 102 is scanned. The reflection light from the original document is similarly introduced into the CCD 28 of the carriage 30 and provides an image.

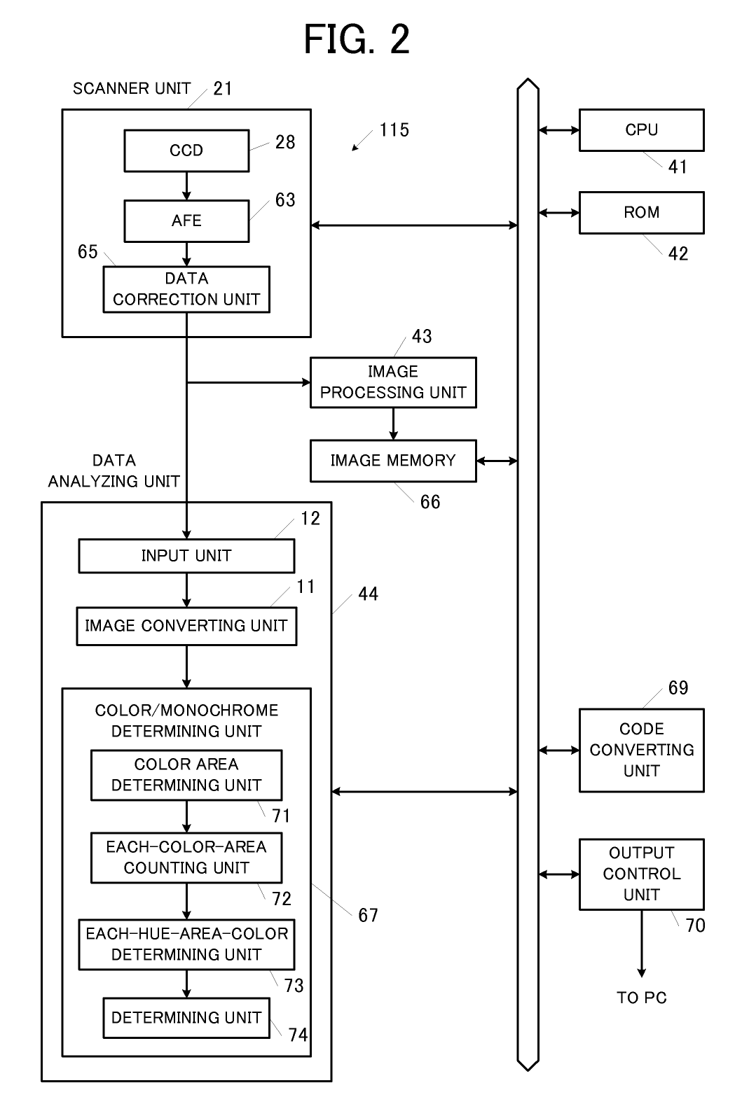

FIG. 2 is a block diagram of the image scanner apparatus 101. As illustrated in FIG. 2, in addition to the scanner unit 21, the image scanner apparatus 101 preferably includes a Central Processing Unit (CPU) 41, a Read Only Memory (ROM) 42, an image processing unit 43, an image memory 66, a data analyzing unit (an image processing device) 44, a code converting unit 69, and an output control unit 70.

The CPU 41 is provided as a control unit that controls, for example, the scanner unit 21, the data analyzing unit 44, and the output control unit 70 which are included in the image scanner apparatus 101. Programs and data or the like used for the control are stored in the ROM 42 which defines a storage unit.

The scanner unit 21 preferably includes an Analog Front End (AFE) 63, which is connected with the CCD 28. At the time of scanning the original document, the line sensor of each color of RGB included in the CCD 28 scans one line of the original document content in the main scanning direction, and the signal of each line sensor is converted from an analog signal into a digital signal by the AFE 63. By this main scanning operation, pixel data of one line is output as a tone value of each color of RGB from the AFE 63. By repeating the above-described process while the original document or carriage 30 is being transported gradually in the sub scanning direction, the image data of the entire original document can be acquired as digital signals.

The scanner unit 21 preferably includes a data correction unit 65. The digital signals of the image data output from the AFE 63 are input into the data correction unit 65. The data correction unit 65 performs shading correction on the image data that is input one line at a time with respect to each main scanning operation, and corrects scanned unevenness that arises from an optical system of the scanner unit 21. The data correction unit 65 preferably performs, on the pixel data, correction that corrects the scan position displacement caused by arrangement intervals (line gaps) of the line sensor of each color of RGB in the CCD 28.

The image memory 66 stores images scanned by the scanner unit 21. After a well-known image processing method (such as a filtering process) is performed in the image processing unit 43, the image data scanned by the scanner unit 21 is input into the image memory 66 and stored.

The data analyzing unit 44 preferably includes an input unit 12, an image converting unit 11, and a color/monochrome determining unit 67. The input unit 12 receives the digital image data from the scanner unit 21. The image converting unit 11 performs a well-known color space converting process, or the like, on the digital image data. The color/monochrome determining unit 67 determines whether the original document of the image scanned by the scanner unit 21 is a color document or a monochrome document. An operation of the color/monochrome determining unit 67 will be described later in detail.

The code converting unit 69 encodes the image data stored in the image memory 66, by performing a well-known compression process, such as, a Joint Photographic Experts Group (JPEG), for example.

The output control unit 70 transmits the encoded image data to, for example, a personal computer (not illustrated) defining a higher-level device connected with the image scanner apparatus 101. A transmission method may be selected and includes, for example, a method that uses a Local Area Network (LAN) and a method that uses a Universal Serial Bus (USB).

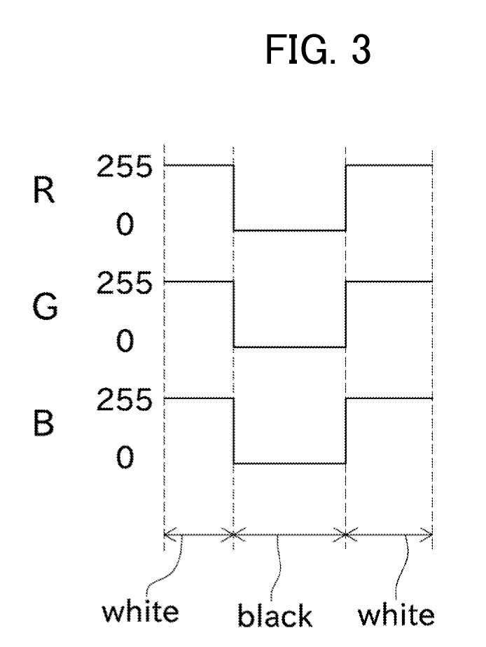

With reference to FIGS. 3 through 6, false color occurrence arising from the image displacement will be described. FIGS. 3 through 6 conceptually illustrate a state of the RGB signals, which are scanned by the 3-line CCD, at a portion of a monochrome document where white changes into black, and further into white in the sub scanning direction. The RGB signals refer to the signals on which the line gap correction has been performed through the data correction unit 65.

FIG. 3 illustrates a situation where there is no image displacement and the RGB components do not generate a color shift (i.e., where the RGB components harmonize). In other words, in FIG. 3, a black portion of the document is scanned as a black pixel ([R, G, B]=[0, 0, 0]), and a white portion of the document is scanned as a white pixel ([R, G, B]=[255, 255, 255]). The RGB values have been described as above for convenience, however, the RGB values of black and white of actual image data do not necessarily correspond to a minimum value and a maximum value, respectively.

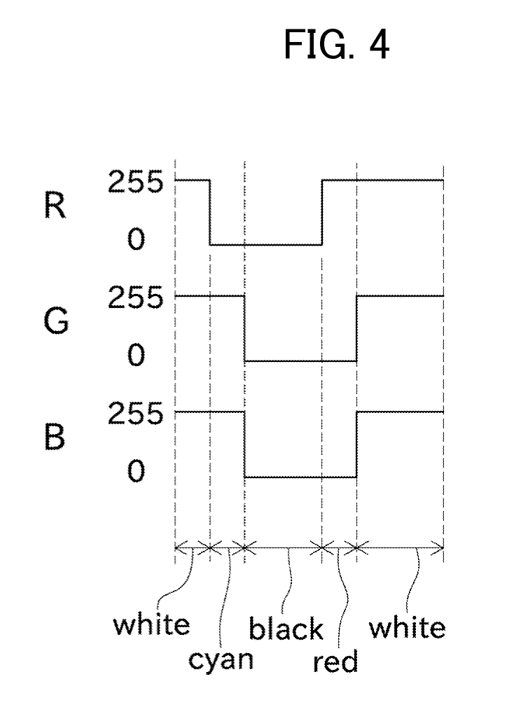

Meanwhile, FIGS. 4 through 6 illustrate a situation where image displacement occurs when the original document is scanned, and where a color shift is generated in any of the RGB components.

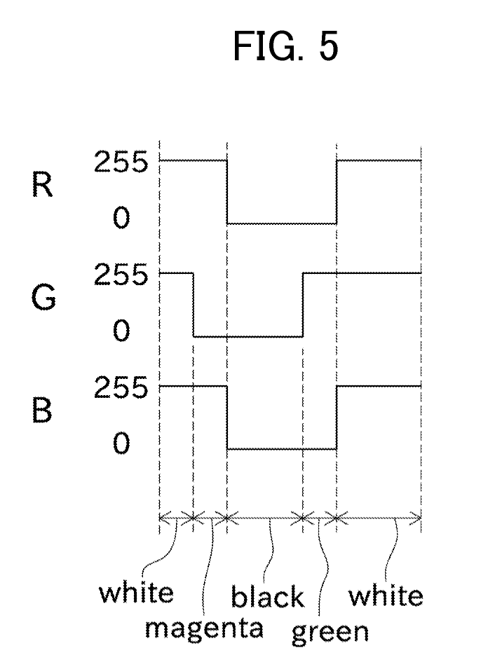

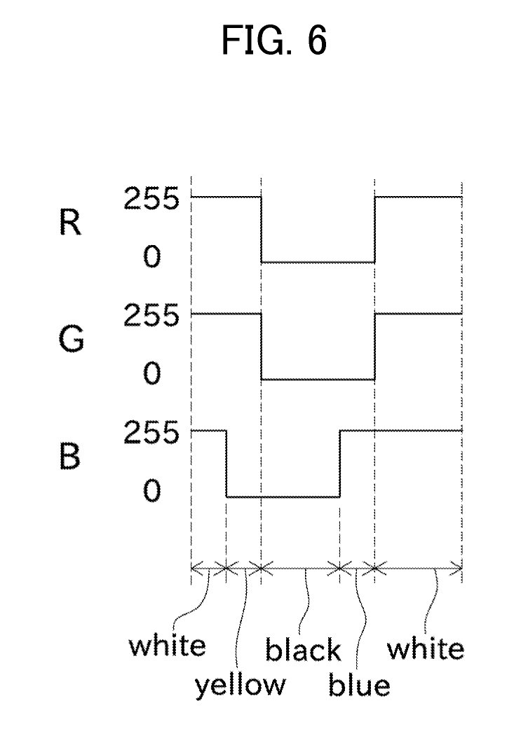

FIG. 4 illustrates a situation where a color shift is generated in the R component. As illustrated in FIG. 4, when the R component shifts with respect to other components (i.e., the G and B components), a false color is generated in the image data. More specifically, in the case of a monochrome original document, a red pixel ([R, G, B]=[255, 0, 0]) appears at a portion adjacent to one side of a black pixel, and a cyan pixel ([R, G, B]=[0, 255, 255]), which is a complementary color of red, appears at a portion adjacent to the other side of the black pixel. Thus, chromatic colors (false colors) are generated at a boundary between the black color and the white color in the document. Similarly, when a color shift is generated in the G component, a green pixel and a magenta (i.e., a complementary color of green) pixel appear (FIG. 5), and when a color shift is generated in the B component, a blue pixel and a yellow (i.e., a complementary color of blue) appear (FIG. 6).

Thus, even when the original document is monochrome, the chromatic colors (false colors) may appear because of the image displacement in the image data, and a pixel of the false color may lead to an erroneous determination in which the monochrome document is determined as a color document.

Next, a color/monochrome determination of the original document made by the data analyzing unit 44 will be described. As illustrated in FIG. 2, the color/monochrome determining unit 67 of the data analyzing unit 44 includes a color area determining unit (a hue determining unit) 71, an each-color-area counting unit (each-hue-area counting unit) 72, an each-hue-area-color determining unit 73, and a determining unit 74.

When the image data (described in an RGB color coordinate system) scanned by the scanner unit 21 is input into the input unit 12 of the image processing unit 43, the data is converted into a YCbCr color coordinate system by the image converting unit 11. In the following description, a two-dimensional plane defined by two parameters that are related to the hue in the YCbCr color space will be referred to as a “hue plane”. The two parameters “Cr” and “Cb” represent a color difference component of red and a color difference component of blue, respectively, and range from −128 to 127. A value of “0” indicates a complete achromatic color difference.

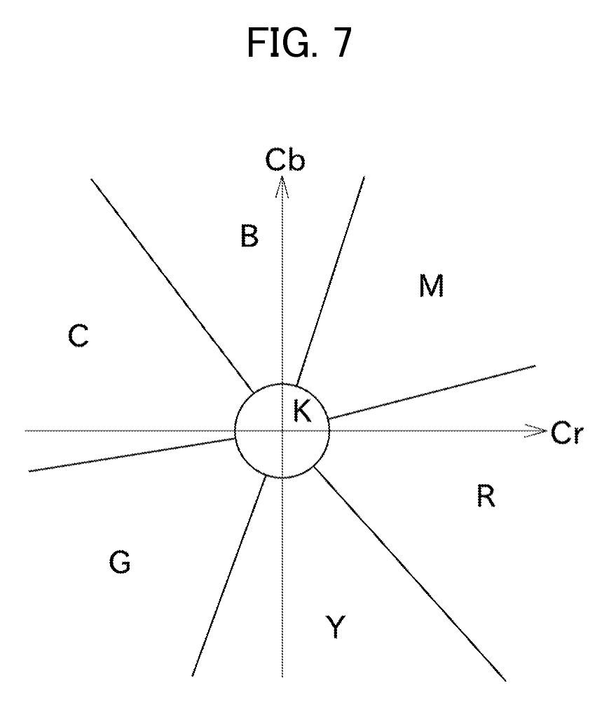

FIG. 7 is a schematic diagram of the hue plane. In the present preferred embodiment, as illustrated in FIG. 7, the hue plane is divided into a plurality of color areas. One achromatic area (K) and six hue areas (blue B, magenta M, red R, yellow Y, green G, and cyan C) are set in the hue plane. The six hue areas (chromatic areas) are defined by dividing the chromatic color space into six in hue directions. Each hue area has a complementary color hue area, for example, blue B and yellow Y, so that the pair of hue areas will be in a complementary-color relationship.

It is defined that the achromatic area K corresponds to an area that is within a range from the origin (Cb=0, Cr=0) to a distance “10”, for example. In this case, the achromatic area preferably has a round shape as show by the area K in FIG. 7. The achromatic area is used to define the extent to which the color is determined as monochrome. Accordingly, it is preferable to set an appropriate range in view of characteristics etc. of the CCD 28. The range of the achromatic area may be changed in accordance with the needs of a user.

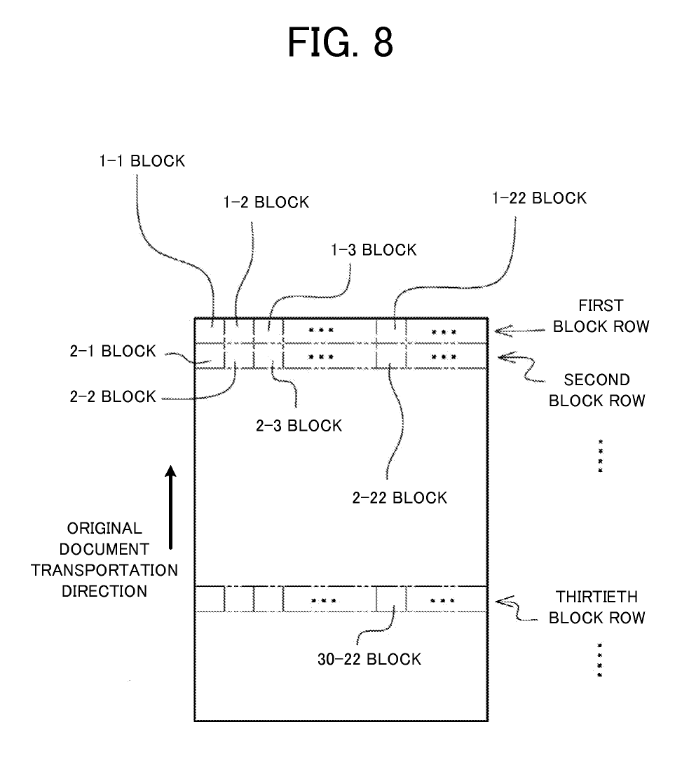

The color/monochrome determining unit 67 divides the original document data converted into the YCbCr color coordinate system by the image converting unit 11 into prescribed blocks (image areas) consisting of a plurality of pixels, and analyzes the data. More specifically, as illustrated in FIG. 8, the image data is divided into grid-shaped vertical and horizontal blocks. Further more specifically, 50×70 pixels correspond to one block, for example. The most appropriate value is properly selected as a size of the block in accordance with conditions such as a size of the original document and a scanning resolution, for example. The color/monochrome determining unit 67 determines whether the document is color or monochrome by comprehensively evaluating an analysis result of the entire image and an analysis result of each block. In the following description, in order to specify each of the divided blocks, the rows of blocks aligning in the main scanning direction are referred to as a first block row, a second block row, etc., counted from a leading end of a transportation direction of the original document. Moreover, each block in the “n”th block row is referred to as a n-1 block, a n-2 block, etc., counted from the left.

The color area determining unit 71 of the color/monochrome determining unit 67 determines which color area of the hue plane of FIG. 7 a CbCr value of each pixel of a block belongs to. Further, when the pixel color is chromatic, the color area determining unit 71 can determine which hue area of the six hue areas the pixel belongs to. Subsequently, each-color-area counting unit 72 counts the number of pixels that have been determined to belong to each color area.

The number of pixels determined by the color area determining unit 71 to belong to any of the six hue areas (chromatic areas) is separately counted. Thus, the color/monochrome determining unit 67 can count and acquire the number of chromatic pixels of the entire image.

Each time one block is analyzed, the each-hue-area-color determining unit 73 checks, with respect to the block, a count result of each color area obtained by the each-color-area counting unit 72. Then, if the counted value of any hue area exceeds a prescribed threshold value, the each-hue-area-color determining unit 73 determines that a chromatic color exists. Then, the each-hue-area-color determining unit 73 stores in information regarding a position of the block a memory (not illustrated), the color area (hue) in which the chromatic color has been determined to exist, and the counted value of the pixels in the color area. As a result, the information indicating that the chromatic color exists in the hue areas B and Y of a 30-22 block, that 80 pixels are counted in the hue area B, and that 70 pixels are counted in the hue area Y, is stored in the memory, for example.

When the determination with respect to each block is completed, the determining unit 74 determines whether the original document is color or monochrome based on a result of the series of processes.

In the determining method, in principle, when the number of chromatic pixels of the entire image exceeds a prescribed threshold value (a first threshold value), it is determined that the original document is color, and when the number of chromatic pixels of the entire image falls below the threshold value, it is determined that the original document is monochrome. However, as described above, when a color shift arising from the image displacement is generated, a false color appears in the image data. Accordingly, in the above-described principle determination, a monochrome original document may be erroneously determined as a color document. A method of preventing such erroneous determinations will be described below.

The image displacement occurs because of an instantaneous change in a relative speed at a scan position at the time of scanning the original document and oscillation etc. on a scan surface arising from a change of the position of the original document or from a change of a path. However, such causes arise from mechanistic factors of the image scanner apparatus 101. Therefore, under the same conditions, a portion where the image displacement occurs is limited. That is, the image displacement tends to occur only at a certain position from a leading edge or a trailing edge of the original document. Accordingly, an area in which the color shift tends to be generated will be hereinafter referred to as a color shift expected area. A more accurate determination can be made with respect to the color shift expected area under conditions differing from that of other areas.

Since the image displacement occurs because of the above-described causes, the color shift tends to be generated on a substantially straight line that is substantially parallel to the main scanning direction. Accordingly, the color shift expected area preferably has an elongated shape that extends in the main scanning direction. In the present preferred embodiment, among the block rows (the first block row, the second block row, etc. of FIG. 8) aligning from one end of the document to the other end in the main scanning direction, the block row in which the color shift tends to be generated is specified as the color shift expected area (a method of specifying the color shift expected area will be described later). For example, the 30th block row is specified as the color shift expected area. A plurality of block rows may be specified as the color shift expected areas.

In the description above, it is assumed that 50×70 pixels correspond to one block. For example, a size of the image data corresponds to 4960×7016 pixels at the time when an original document of A4 size is scanned at 600 dot per inch (dpi). In this case, a size of one color shift expected area (i.e., a size of one block row) corresponds to 4960×70 pixels. Thus, the color shift expected area has the elongated shape extending in the main scanning direction.

A prescribed block row on the leading edge side in the transportation direction of the original document and a prescribed block row on the trailing edge side, or the like, are specified as the color shift expected areas. In other words, the image displacement tends to occur particularly on the leading edge side of the original document because the document makes contact with the path guide 31, changing the path, and on the trailing edge side because a transportation speed instantaneously changes at the time when the document escapes from the transportation roller 55. As a result, the block rows that correspond to such areas are likely to be specified as the color shift expected areas.

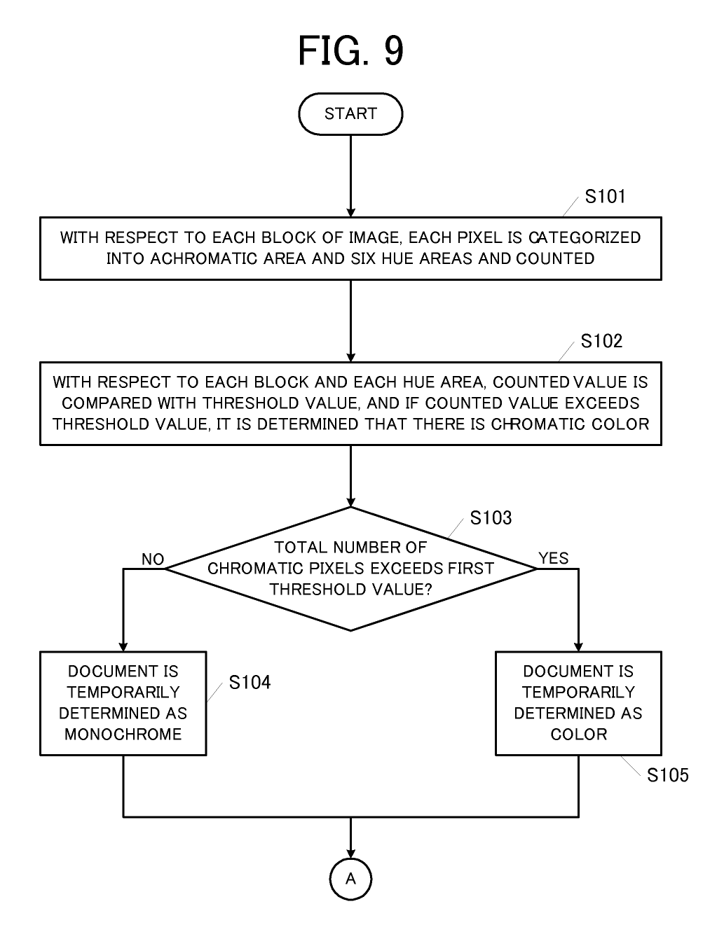

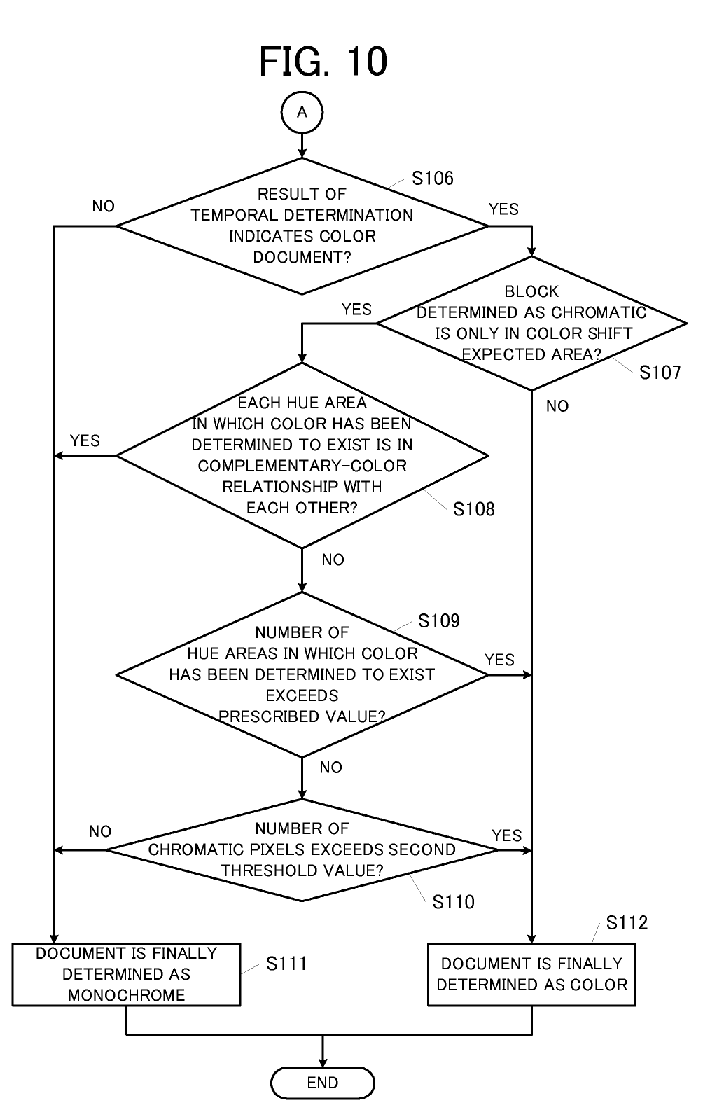

With reference to FIGS. 9 and 10, a color/monochrome determining process will be described. FIGS. 9 and 10 are flowcharts of the color/monochrome determining process carried out by the color/monochrome determining unit 67.

First, with respect to each block that is set by dividing the image as illustrated in FIG. 8, it is determined which one of the achromatic area and the six hue areas (i.e., six chromatic areas) each pixel belongs to, and the pixels are counted with respect to each color area (S101 of FIG. 9). The pixels that are determined to belong to any of the six hue areas (chromatic areas) are separately counted, and the number of chromatic pixels of the entire image is acquired by calculation.

Then, with respect to each block, the counted value of each hue area is compared with the prescribed threshold value, and it is determined whether or not there is a chromatic color (S102). Information about the block and hue area in which the chromatic color has been determined to exist is properly stored in the memory.

Then, it is temporarily determined whether the original document is a color document or a monochrome document (S103). The temporal determination is based on the principle of the color/monochrome determining method, i.e., the temporal determination is made depending on whether or not the total number of chromatic pixels of the entire image exceeds the prescribed threshold value (the first threshold value). Therefore, at least some information (grounds) that is used in the temporal determination may include the chromatic pixels and their complementary color pixels of the color shift expected area.

As a result of the determination made in S103, when the number of chromatic pixels falls below the first threshold value, it is temporarily determined that the original document is a monochrome document (S104). Meanwhile, when the number of chromatic pixels exceeds the first threshold value, it is temporarily determined that the original document is a color document (S105).

The first threshold value is properly determined in association with the threshold value used in the process of S102. When any block is determined to be chromatic in the process of S102, it is always temporarily determined in the process of S103 that the original document is a color document.

Next, a flow of a final determination illustrated in FIG. 10 (i.e., a process of preventing an erroneous determination arising from a false color) is carried out. In the flow of the final determination, the result of the temporal determination is checked first (S106). If it is temporarily determined that the original document is not a color document (i.e., that the original document is a monochrome document), it is finally determined that the original document is a monochrome document (S111), and the process is ended.

When it is temporarily determined that the original document is a color document, it is checked (S107) whether or not the block in which the chromatic color has been determined to exist (hereinafter, referred to as a chromatic block) in S102 is in the specified color shift expected area. Moreover, when it is determined that a chromatic color exists in other blocks than the block that is in the color shift expected area, it is assumed that the chromatic pixels in the other blocks are not caused by a false color. Accordingly, it is finally determined that the original document is a color document (S112), and the process is ended.

Meanwhile, when it is determined that the chromatic color exists only in the block of the color shift expected area, in which the image displacement tends to occur, it is highly likely that a false color is generated in the monochrome document. Accordingly, when it is determined in S107 that all of the chromatic blocks are within the color shift expected area, a further detailed determination is made in the following process.

First, it is checked (S108) whether or not the hue areas in which the colors have been determined to exist with respect to the chromatic block are in the complementary-color relationship. In other words, with respect to the hue area in which the color has been determined to exist with respect to the chromatic block, it is checked, with respect to the corresponding block, whether or not the color exists in the other hue area which is in the complementary-color relationship with the former hue area.

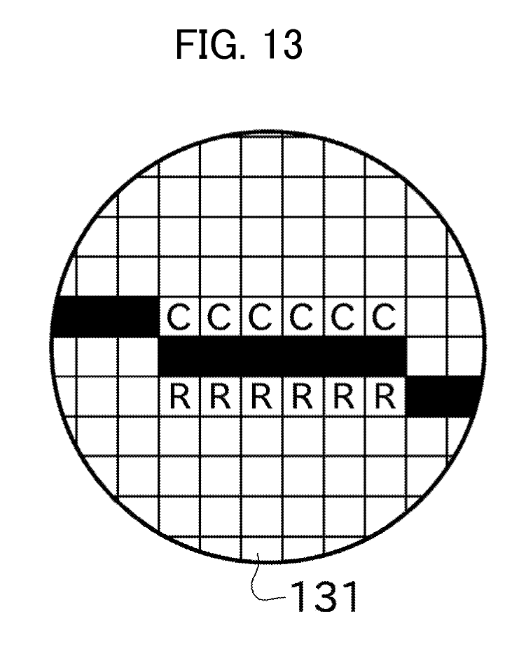

The determination is based on the tendency that both the chromatic pixels and their complementary color pixels are detected at both ends of a black portion as described above when the false color is generated at the black portion of the original document because of the color shift (for example, refer to FIGS. 4 and 13). In the determination made in S108, if it is determined that the colors exist in both of the hue areas that are in the complementary-color relationship with each other, and if any color is not detected in the other hue areas, it is assumed that the false color is generated in the monochrome document because of the color shift. Therefore, the temporal determination indicating that the original document is color is reversed, and it is finally determined that the original document is monochrome (S111). Thus, the process is ended, or the process proceeds to S109 in other cases.

In the determination made in S108, it can be further considered whether or not the counted value of the pixels in the hue area is substantially the same as the counted value of the pixels in the other hue area which is in the complementary-color relationship with the former hue area (i.e., whether or not the difference between the counted values of the pixels falls below a prescribed value). In other words, when the false color is generated at the black portion of the original document because of the color shift, although depending on a shape of a graphic of the black portion, it is highly likely that the number of specific color pixels and the number of their complementary color pixels to be detected at the both ends of the black portion are substantially the same. Therefore, even when it is determined that the colors exist in the two hue areas that are in the complementary-color relationship, if the counted value of the pixels in each of the hue areas is greatly different from one another, it is hardly likely that the false color is generated because of the color shift. Accordingly, it is not finally determined that the original document is monochrome, and the process can proceed to S109.

Further, although the false colors are generated at the both ends of the black portion, the false color has a width of only a few dots, for example, and it is hardly likely that the number of false color pixels is greater than the number of black pixels. Accordingly, the determination indicating that the original document is monochrome can be made as follows. That is, the number of black pixels is counted with respect to each block, and in a case where the hue areas that are in the complementary-color relationship have been determined to be chromatic, it is determined in S108 that the original document is monochrome only when the counted value of the black pixels exceeds the counted value of the pixels of the hue area of one side. Alternatively, instead of simply comparing the counted value of the black pixels with the counted value of the pixels of the hue area, it can be determined that the original document is monochrome only when the counted value of the black pixels is greater than a value that is obtained by multiplying the counted value of the pixels of the hue area of one side by a prescribed number (for example, multiplying by two). Such a prescribed multiplying factor may be properly changed. For example, by multiplying the counted value of the black pixels by 0.5, and by comparing the value with the counted value of the pixels of the hue area of one side, a similar result can be acquired.

When the false color is generated at the black portion of the monochrome document, the chromatic pixels are detected at a portion adjacent to one side of the black pixels in the sub scanning direction of the original document, and their complementary color pixels are detected at a portion adjacent to the other side. Accordingly, when it is detected in the determination made in S108 that the pixels of the two hues that are in the complementary-color relationship and the black pixels are in the above-described position relation, it can be finally determined that the original document is monochrome.

Then, it is checked, with respect to the chromatic block, whether or not the number of hue areas in which the colors have been determined to exist exceeds a prescribed value (S109). For example, when it is determined that a color exists in all the six hue areas, it is hardly likely that all the chromatic colors are false colors even in the block of the color shift expected area. Thus, it is finally determined that the original document is a color document (S112), and the process is ended.

When the number of hue areas that have been determined as chromatic is within the prescribed number, it is checked whether or not the total number of chromatic pixels exceeds a prescribed threshold value (a second threshold value) (S110). Then, when the total number of chromatic pixels falls below the second threshold value, it is finally determined that the original document is a monochrome document (S111). When the total number of chromatic pixels exceeds the second threshold value, it is finally determined that the original document is a color document (S112). Then, the process is ended.

In other words, because the false color arising from the color shift is detected with a width of one or few more dots, for example, when the total number of chromatic pixels is extremely large, it is hardly likely that all the chromatic pixels arise from the false color(s). Accordingly, it can be assumed that such pixels may include chromatic color(s) of a color document. As a result, it is finally determined that the original document is color. Meanwhile, when the total number of chromatic pixels falls below a certain value, it can be assumed that all the chromatic pixels arise from the false color(s). Accordingly, it is finally determined that the original document is monochrome.

The second threshold value, which is used in the determination made in S110, is greater than the first threshold value, which is used in the determination made in S103. In other words, since it is already determined at the time of determination made in S110 that the chromatic pixels are detected mainly in the block of the color shift expected area, conditions under which the original document is finally determined as the color document are set to be strict in view of a high possibility of false color occurrence.

In the above-described processes, erroneous color/monochrome determinations can be effectively prevented. Thus, after the color/monochrome determination is properly made, the subsequent image data processing such as selecting a compression method through the code converting unit 69 can be properly carried out, for example.

Further, it is sometimes desired to scan, as a color document, an original document that is monochrome in almost all of the areas of the document but includes, in a small area, chromatic colors that are in the complementary-color relationship and a black portion disposed therebetween. However, when such an original document is scanned, the original document may be determined as a monochrome document if the chromatic color(s) is detected at a position of the color shift expected area. In view of such cases, in the present preferred embodiment, a function of preventing the erroneous determinations that are made because of the false color may be temporarily cancelled in accordance with a user's instruction, and the result of the temporal determination may be used as the result of the final determination.

As described above, the image displacement in the image data tends to occur especially when the original document is transported and then scanned by the ADF 107. In view of such tendency, in the image scanner apparatus 101 including the ADF unit and the flatbed unit according to the present preferred embodiment, a controlling operation of preventing the erroneous determinations made because of the false color may be performed at the time of scanning the document through the ADF unit, and such a controlling operation of preventing the erroneous determinations may not be performed at the time of scanning the document through the flatbed unit. Thus, the erroneous determination preventing function can be effectively used by the automatic switching.

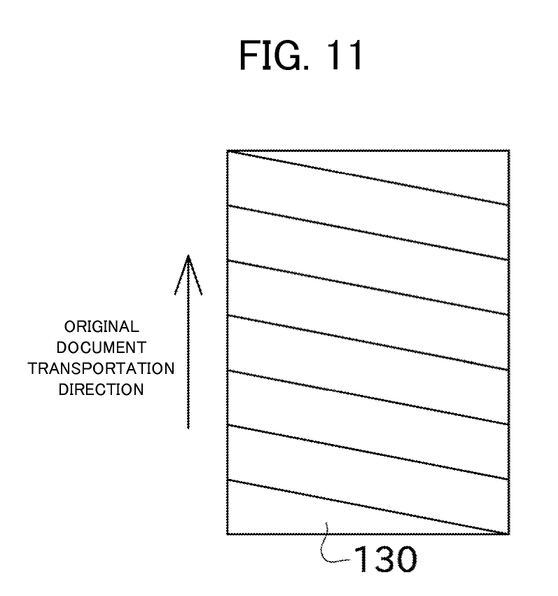

A method of specifying the color shift expected area will now be described. As described above, in the present preferred embodiment, the block row in which the color shift tends to be generated is specified as the color shift expected area. The method of specifying the block row is carried out through a method of scanning a test chart original document 130 illustrated in FIG. 11 by the image scanner apparatus 101.

As illustrated in FIG. 11, a diagonal line pattern repeatedly arranged at prescribed intervals is printed on the test chart original document 130 in monochrome. The line is a straight line that is slanted at an angle of prescribed degrees with respect to the main scanning direction, but it may also be a zigzagged in a staircase pattern if desired. In reality, it is difficult to print a complete straight line obliquely. Accordingly, such a line in a staircase pattern is printed. A width of the line preferably corresponds to one pixel or a few more pixels.

The test chart original document 130 of FIG. 11 will be described in detail with specific numeric values. The test chart original document 130 may be created by being printed through a proper printer or the like, for example. In the case of using the printer having the resolution of 600 dpi, the image data that is handled when the test chart original document 130 is printed preferably corresponds to 4960×7016 pixels in a paper of A4 size.

As described above, a plurality of diagonal lines are repeatedly drawn in a lengthwise direction of the A4-size paper (i.e., in the sub scanning direction). More specifically, the entire area of the A4-size paper is divided by 160 pixels in the sub scanning direction, and each of the divided area (which corresponds to 4960×160 pixels) has the diagonal line, which thereby forms chart patterns.

Because of bit map processing of the printer, in each of the diagonal lines (having the width of one pixel), a prescribed number of black pixels are aligned in the main scanning direction, a next pixel is moved by one pixel from the last pixel of the aligned pixels in the sub scanning direction, and a next prescribed number of black pixels are further aligned from the position of the moved pixel in the main scanning direction. By having such processes repeated, each of the diagonal lines is drawn. The number of black pixels aligned in the main scanning direction is 31 (i.e., 4960/160=31). In other words, a pattern in which the straight lines each having a width of 31 pixels are aligned such that each straight line is moved by one pixel from one another is repeatedly drawn in the entire paper, and thus, the test chart original document 130 is printed. Such a test chart original document 130 has edges (boundaries) where the color changes from black to white or from white to black in the entire area in the sub scanning direction.

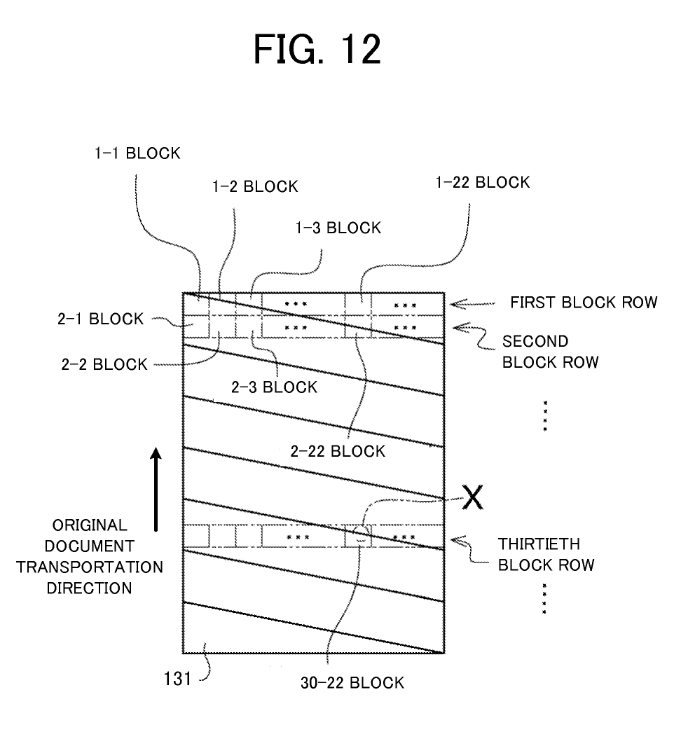

The test chart original document 130 is scanned, and a test chart image 131 (FIG. 12) is obtained after the line gap correction is performed. The color shift expected area can be specified based on the test chart image 131 by using some of the configuration of the color/monochrome determining unit 67 as described below. Thus, a special configuration for analysis of the test chart becomes unnecessary, which thereby reduces a manufacturing cost of the apparatus.

For example, it is assumed that, as a result of the image displacement occurrence, chromatic pixels are generated in an area X of the test chart image 131 as illustrated in an enlarged view of FIG. 13. In FIG. 13, “R” denotes a red pixel, and “C” denotes a cyan pixel.

In the color/monochrome determining unit 67, the test chart image 131 is divided into the blocks, and it is determined whether or not a chromatic color exists in each block. More specifically, the color area determining unit 71 determines, with respect to each block, which one of the achromatic area (K) and the hue areas (i.e., blue B, magenta M, red R, yellow Y, green G, and cyan C) each pixel of the block belongs to. Then, the each-color-area counting unit 72 counts the number of pixels that have been determined to belong to the hue areas.

Each time the analysis of one block is completed, the each-hue-area-color determining unit 73 checks the count result of the hue area of the block obtained through the each-color-area counting unit 72. When a pixel that belongs to a hue area is detected, the each-hue-area-color determining unit 73 stores a position of the corresponding block in a memory (not illustrated). In other words, since it is already determined that the test chart image 131 is monochrome, when even one pixel is counted in the hue area, it can be immediately determined that the pixel is a false color. Therefore, a value “0” is set as a threshold value that is compared with the counted value of the pixels that belong to the hue area, in order to determine that there is a chromatic color. For a similar reason, it is not necessary to execute the function of preventing the color/monochrome erroneous determinations, the function such as counting and comparing the counted value of the pixels that belong to the hue areas that are in the complementary-color relationship with each other, or checking a position relation of the black pixels and the chromatic pixels.

In accordance with user's needs, the counted value of the pixels that belong to the hue area may be compared with a prescribed threshold value that is more than or equal to 0 (the threshold value may be different from the threshold value that is used for the color/monochrome determination), and it can be set such that the false color is determined to have occurred only when the counted value exceeds the threshold value. It can be set such that a range of the achromatic area (K) is different from the range that is used in the normal color/monochrome determination.

The color/monochrome determining unit 67 determines that the block that has been determined, by the each-hue-area-color determining unit 73, to include the chromatic color (false color) is a block in which the color shift arising from the image displacement tends to be generated. Accordingly, the color/monochrome determining unit 67 stores a position of such a block (hereinafter, referred to as a color shift expected block). For example, as illustrated in FIG. 12, when the pixels in which the false color is generated are included in the 30-22 block, it is recorded that the block is the color shift expected block.

When the determination regarding the existence of the false color is completed with respect to each block, the color/monochrome determining unit 67 determines which block row includes the color shift expected block. Accordingly, the block row including the color shift expected block is stored as the color shift expected area. In the present example, the 30th block row, which includes the 30-22 block, is recorded as the color shift expected area. Thus, the position of the color shift expected area is automatically set, and the information thereof can be used in the color/monochrome determination.

The color shift expected block is not limited to only one block, and accordingly, the color shift expected area is not limited to one area. A plurality of color shift expected areas, such as the 8th block row, the 15th block row, and the 21st block row, may be in the image data. In such a case, the color/monochrome determining unit 67 stores all of the information regarding the positions of the plurality of color shift expected areas.

When the test chart original document 130 is scanned through the ADF 107, and when an original document transportation speed can be changed, it is preferable to transport the test chart original document 130 at high speed, and to automatically set the color shift expected area. The higher the original document transportation speed is, the more the color shift tends to be generated. Therefore, by transporting the test chart original document 130 at high speed in order to unfailingly generate the color shift, the color shift expected area can be reliably specified.

Further, the position of the block in which the false color arising from the image displacement tends to be generated depends on structural factors of the apparatus, and also depends greatly on pliableness (flexibility) and a thickness of the original document (especially when the original document is transported and scanned through the ADF 107). In view of such a point, a plurality of test chart original documents 130 of a variety of sizes and a variety of materials are prepared, and by scanning each of the test chart original documents 130 through the image scanner apparatus 101, a plurality of positions of the color shift expected areas are recorded in accordance with the thickness of the document, or the like. Accordingly, the user selects a type of a medium (such as, for example, a paper thickness) at the time of scanning the original document, and the position of the color shift expected area is changed in accordance with the user's selection. Thus, the color/monochrome determination can be accurately made in accordance with the situation.

As described above, since the position of the block in which the false color tends to be generated depends on the structural factors of the apparatus, the position of the color shift expected area in the case of the ADF 107 and the position of the color shift expected area in the case of the flatbed unit are different from each other. In view of such a point, the position of the color shift expected area in the case in which the test chart original document 130 is scanned through the ADF 107 and the position of the color shift expected area in the case in which the test chart original document 130 is scanned through the flatbed unit are separately recorded. Accordingly, when making the color/monochrome determination of the original document, the color shift expected area can be automatically changed (switched) depending on whether the document is scanned through the ADF 107 or through the flatbed unit.

As described above, the data analyzing unit 44 of the present preferred embodiment includes the input unit 12 and the color/monochrome determining unit 67. The input unit 12 is arranged to input the image data scanned through the CCD 28 with the plurality of lines that can scan the color documents. The color/monochrome determining unit 67 determines whether the original document is color or monochrome based on the image data input through the input unit 12. The color/monochrome determining unit 67 includes the color area determining unit 71 arranged to determine the hue of each pixel that is included in the image data. When the chromatic pixels and their complementary color pixels are detected in a specific area (i.e., color shift expected area) as a result of the determination made through the color area determining unit 71, the color/monochrome determining unit 67 makes the color/monochrome determination with respect to the color shift expected area under the conditions that are different from that of the other image areas. More specifically, when the chromatic pixels and their complementary color pixels are detected in the color shift expected area, the detected chromatic pixels and their complementary color pixels are excluded from information that is used in the determination (S108 of FIG. 10).

In the above-described configuration, when the chromatic pixels and their complementary color pixels are detected in the color shift expected block, the pixels can be excluded from the information that is used in the color/monochrome determination. Accordingly, erroneous determinations in which the monochrome document is determined as the color document because of the false color arising from the image displacement can be prevented.

In the data analyzing unit 44 of the present preferred embodiment, the color/monochrome determining unit 67 includes the color area determining unit 71, the each-color-area counting unit 72, the each-hue-area-color determining unit 73, and the determining unit 74. The color area determining unit 71 determines which hue area, which is set by dividing the color space into a plurality of areas in the hue directions, the detected chromatic pixel belongs to. The each-color-area counting unit 72 counts, with respect to each hue area, the number of pixels that have been determined to belong to the corresponding hue area. The each-hue-area-color determining unit 73 compares, with respect to each hue area, the counted number of pixels with the prescribed threshold value, and then determines that there is the color of the corresponding hue area when the counted number of pixels exceeds the threshold value. With respect to each image area obtained by dividing the image data into a plurality of areas, the each-color-area counting unit 72 and the each-hue-area-color determining unit 73 count the number of pixels and make the determinations regarding the existence of colors. The determining unit 74 determines whether the original document of the image data is color or monochrome. Then, with respect to the image area included in the color shift expected area, when the each-hue-area-color determining unit 73 determines that there is a color in two or more hue areas, and further, only when each of the hue areas is in the complementary-color relationship with each other, the determining unit 74 excludes, from the information that is used in the color/monochrome determination, each pixel that is in the image area and that has been determined to belong to any of the above-described pair of hue areas (S107 and S108 of FIG. 10).

In the above-described configuration, in the color shift expected block among the divided blocks, when it is determined that a color exists in a hue area and its complementary color hue area, the pixels in the block and in the hue area can be properly excluded from the information that is used in the determination. As a result, the erroneous determinations of color/monochrome documents can be prevented. Moreover, by counting the number of pixels with respect to each hue area, the information indicating the hue in which the chromatic color is detected can be acquired and used in the determination. Accordingly, the chromatic color arising from the false color and the chromatic color arising from the color document can be effectively distinguished from one another and determined.

When the difference between the number of chromatic pixels and the number of their complementary color pixels both detected in the color shift expected block falls below the prescribed number, in the determination made in S108 of FIG. 10, the color color/monochrome determining unit 67 can exclude the detected chromatic pixels and their complementary color pixels from the information that is used in the determination.

In the above-described configuration, in view of the tendency that the number of chromatic pixels arising from the image displacement does not greatly differ from the number of their complementary pixels, the color/monochrome determination of the original document can be made more reliably.

In the determination made in S108 of FIG. 10, with respect to the color shift expected area, when the number of detected chromatic pixels falls below the threshold value, which is determined based on the number of black pixels, the color/monochrome determining unit 67 excludes the detected chromatic pixels and their complementary color pixels from the information that is used in the determination.

In other words, when the false colors (chromatic color and its complementary color) arising from the image displacement are generated at the boundary of the black portion of the monochrome document, it is highly likely that the number of chromatic pixels appeared at the portion adjacent to one side of the black portion falls below the number of black pixels. Accordingly, by counting the number of black pixels as well as the number of chromatic pixels, and by comparing the number of chromatic pixels with the threshold value determined based on the number of black pixels, the color/monochrome determination of the original document can be made more accurately. Moreover, the processes can be easily performed at high speed through a simple counting process.

In the determination made in S108 of FIG. 10, when the chromatic pixels appear at the portion adjacent to one side of the black pixels in the color shift expected block, and their complementary color pixels appear at the portion adjacent to the other side of the black pixels, the color/monochrome determining unit 67 can exclude the detected chromatic pixels and their complementary color pixels from the information that is used in the determination.

In the above-described configuration, in view of the fact that the chromatic pixels and their complementary color pixels as the false colors arising from the image displacement are detected at the portions that adjacently sandwich the black pixels, the color/monochrome determination of the original document can be made more accurately.

In the determination indicating whether the original document of the image data is color or monochrome, the data analyzing unit 44 of the present preferred embodiment can select a mode (first mode) in which the chromatic pixels and their complementary pixels detected in the color shift expected block are excluded from the information that is used in the determination or a mode (second mode) in which the chromatic pixels and their complementary pixels are included in the information that is used in the determination.

In the above-described configuration, by changing the method of color/monochrome determination in accordance with the contents of the original document and a scanning method, or the like, the determination can be appropriately made.

In the data analyzing unit 44 of the present preferred embodiment, the input unit 12 can input the data of the test chart image 131 obtained by having the test chart original document 130 scanned through the CCD 28. By analyzing the data of the test chart image 131, the color/monochrome determining unit 67 can automatically set the color shift expected block.

In the above-described configuration, even if the blocks in which the color shift tends to be generated differ depending on an individual difference of the image scanner apparatus 101, by analyzing the data of the test chart image 131, the color shift expected area can be properly set. Accordingly, the color/monochrome determination of the original document can be accurately made.

In the data analyzing unit 44 of the present preferred embodiment, the color/monochrome determining unit 67 can change the color shift expected block in accordance with a type of a medium of the original document.

In the above-described configuration, even when the image area in which the false color tends to be generated is changed in accordance with the type of the medium of the original document, the color/monochrome determination can be accurately made.

The image scanner apparatus 101 of the present preferred embodiment includes the scanner unit 21 arranged to scan the original document through the CCD 28 having the plurality of lines capable of scanning the color documents, the ADF 107, and the data analyzing unit 44.

In the above-described configuration, even if the false colors arising from the image displacement are generated in the image data obtained by having the monochrome original document scanned through the CCD 28 of the original document scanning unit, the erroneous determinations in which the monochrome original document is determined as a color document can be prevented. Further, since the false colors arising from the image displacement tend to be generated in the specified blocks when the original document is transported and scanned through the ADF 107, it is particularly preferable to use the color/monochrome determining unit 67 of the present preferred embodiment.

Furthermore, the image scanner apparatus 101 of the present preferred embodiment can also scan the color original document through the flatbed unit. When the original document is transported and scanned through the ADF 107, the color/monochrome determining unit 67 excludes the chromatic pixels and their complementary color pixels detected in the color shift expected area from the information that is used in the color/monochrome determination of the original document. When the original document is scanned through the flatbed unit, the chromatic pixels and their complementary color pixels detected in the color shift expected area can be included in the information that is used in the color/monochrome determination of the original document.

In other words, when the original document is scanned through the flatbed unit, it is unlikely that the color shift is generated compared with the case in which the original document is transported and scanned through the ADF 107. Accordingly, operations can be more effective by not performing the process of preventing the erroneous color/monochrome determinations when scanning the original document through the flatbed unit.

In the image scanner apparatus 101 of the present preferred embodiment, the data analyzing unit 44 is arranged to store the different color shift expected areas and switch the areas between the case in which the original document is transported and scanned through the ADF 107 and the case in which the original document is scanned through the flatbed unit.

In other words, since the area in which the image displacement tends to occur differ between the case in which the original document is transported and scanned through the ADF 107 and the case in which the original document is scanned through the flatbed unit, by enabling to select the area, any method of scanning the original document can be properly handled.

The test chart original document 130 of the present preferred embodiment includes boundaries of a light color and a deep color in the entire area in the sub scanning direction except for a margin.

By scanning the test chart original document 130 by the original document scanning unit, the color shift can be reliably generated in the area in which the color shift tends to be generated, and thus, the area can be specified.

In the color/monochrome determining method of the present preferred embodiment, it is determined whether the original document is color or monochrome based on the image data acquired by having the original document scanned through the CCD 28 having the plurality of lines capable of color-scanning operations. When chromatic pixels of opposite hues are detected on both sides of the black pixel in the color shift expected area, which is the specified image area of the image data, the determination with respect to the color shift expected area is made under the conditions that are different from that of the other image areas. More specifically, the chromatic pixels are excluded from the information that is used in the determination.

In the above-described method, the color shift arising from the image displacement is reliably detected, and thus, the erroneous color/monochrome determinations of the original document can be prevented.

The preferred embodiment and its modification of the present invention have been described above. The above-described configuration can be modified as follows, for example.

The function of the data analyzing unit 44 may be implemented by using hardware other than the CPU 41 (for example, by using an Application Specific Integrated Circuit), or may be implemented by using proper software in the CPU 41.

In place of the configuration in which the image scanner apparatus 101 includes the data analyzing unit 44, an external device maybe used. For example, the configuration maybe modified such that the function of the data analyzing unit is implemented by executing proper software on a personal computer that is connected with the output control unit 70.

In the above description, the color/monochrome determination is made with respect to the entire original document, however, the process of preventing the erroneous color/monochrome determinations of the present invention may be applied to the time when making the color/monochrome determination on a portion of the area of the original document. Thus, by performing the process of preventing the erroneous color/monochrome determination on the portion of the original document, the most appropriate method can be selected when selecting a compression method for the image data, for example.

In the present preferred embodiment, in the descriptions of FIGS. 9 and 10, the exclusion determination (the processes of S107 through S109 of FIG. 10) is performed after the original document is temporarily determined as a color document (S105 of FIG. 9). In place of such a configuration, a portion or the entire exclusion determination process may be performed when it is determined whether or not each block is a chromatic block (S102 of FIG. 9). In such a case, the accuracy of the temporal determination in S105 is raised, although time required for performing the temporal determination may be increased. The exclusion determination may be performed at a proper timing in view of the above-described trade-off relationship.

The pattern of the test chart original document 130 is not limited to the above-described pattern, and may be modified as long as the pattern includes boundaries (edge) of a light color and a deep color in the substantially entire area (except for the margin) in the sub scanning direction. At the time of scanning the test chart original document 130, detecting the occurrence of false colors is sufficient, and as long as it is determined that a monochrome test chart original document 130 is used, it is not necessarily required to detect the pixels that are in the complementary-color relationship. Accordingly, the pattern is not limited to thin lines. That is, as long as the entire area has the boundaries from the deep color to the light color or the boundaries from the light color to the deep color in the sub scanning direction, the occurrence of the false colors can be confirmed. Further, it is sufficient if the position where the false color is generated is confirmed. Therefore, the test chart original document 130 is not limited to the printing in monochrome, and it is sufficient if the test chart original document 130 is printed in a color that is in the range determined to be in the achromatic area (K). The test chart original document 130 may be printed in color, however, the process of determining the false colors will be complicated in such a case. Accordingly, it is preferable to print the test chart original document 130 in monochrome.

In the case of scanning the test chart original document 130 and setting the color shift expected area, when even one chromatic block is detected in a block row, the block row may be set as the color shift expected area, or only when the number of chromatic blocks exceeds the prescribed threshold value, the block row may be set as the color shift expected area. The threshold value may be properly changed.

The color coordinate conversion performed through the image converting unit 11 is not limited to the YCbCr color coordinate, and other image data representing methods that use a three-dimensional color space and that include a chromatic axis, such as a Lab color space, a Luv color space, and a YIQ color space, or the like, may be used. The hue determination may be made with respect to each RGB pixel without performing the color coordinate conversion on the entire RGB image data. When using the data after performing a JPEG compressing process thereon through the code converting unit 69, since the YCbCr is adopted in the JPEG format, it is more efficient to convert the data into the YCbCr color coordinate in advance.

A color area dividing method is not limited to the method illustrated in FIG. 7. For example, a chromatic color space may be divided into eight in the hue directions in order to determine (set) the hue areas.

A method of dividing the image data into the blocks is not limited to the above-described configuration. For example, the configuration may be modified such that an elongated area extending in the main scanning direction as the block row may be set as the block. However, it is preferable to determine the hue area in a relatively small area, and the false colors arising from the image displacement are generally generated in the entire line in the main scanning direction. Therefore, for the process of preventing the erroneous determinations, it is preferable to divide the grid-like blocks as the present preferred embodiment and then determine the hue areas, and also to set, as the color shift expected area, the elongated block rows having the blocks aligning in the main scanning direction.

The shape of the color shift expected area is not limited to the shape in which the blocks are aligned in the main scanning direction as described above, and may be other suitable shapes. However, in view of the fact that the color shift tends to be generated extending in the main scanning direction, it is preferable that the color shift expected area extends in the main scanning direction.

The image scanning sensor is not limited to the CCD, and other suitable sensors may be applied to the present invention. For example, the number of lines of the sensor is not limited to three, and 2-line or 4-line image scanning sensor may be used in the original document scanning unit of the present invention.

The above-described process of preventing the color/monochrome erroneous determinations is not limited to the image scanner apparatus 101, and may be applied to other original document scanning apparatus such as a copier, and a Multi Function Peripheral, for example.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image processing apparatus comprising:
an input unit arranged to input image data that is obtained by scanning an original document through a sensor having a plurality of lines that can scan color documents; and
a color/monochrome determining unit arranged to determine whether the original document or a portion of the original document is color or monochrome based on the image data input through the input unit; wherein
the color/monochrome determining unit includes a hue determining unit arranged to determine a hue of each pixel that is included in the image data; and
as a result of the determination made by the hue determining unit, when chromatic pixels and their complementary color pixels are detected in a color shift expected area, which is a specified image area of the image data, the color/monochrome determining unit makes the color/monochrome determination with respect to the color shift expected area under conditions differing from conditions of other image areas.

2. The image processing apparatus according to claim 1, wherein the color/monochrome determining unit excludes the chromatic pixels and their complementary color pixels detected in the color shift expected area from information that is used in the color/monochrome determination.

3. The image processing apparatus according to claim 2, wherein
the hue determining unit is arranged to determine which hue area, which is set by dividing a color space into a plurality of areas in hue directions, the detected chromatic pixels belong to;
the color/monochrome determining unit further includes:
an each-hue-area counting unit arranged to count, with respect to each hue area, the number of pixels that have been determined to belong to the corresponding hue area;
an each-hue-area-color determining unit arranged to compare, with respect to each hue area, the counted number of pixels with a prescribed threshold value, and then determine that there is a color of the corresponding hue area when the counted number of pixels exceeds the threshold value; and
a determining unit arranged to determine whether the original document or a portion of the original document of the image data is color or monochrome;
the each-hue-area counting unit and the each-hue-area-color determining unit count the number of pixels and determine the existence of the color with respect to each image area, which is set by dividing the image data into a plurality of areas; and
with respect to the image area included in the color shift expected area, when the each-hue-area-color determining unit determines that there is a color in at least two hue areas, and further, only when each hue area is a pair of hue areas that are in a complementary-color relationship with each other, the determining unit excludes each pixel that is in the image area and that has been determined to belong to any of the pair of the hue areas from the information that is used in the color/monochrome determination.

4. The image processing apparatus according to claim 2, wherein when a difference between the number of chromatic pixels and the number of their complementary color pixels detected in the color shift expected area falls below a prescribed value, the color/monochrome determining unit excludes the detected chromatic pixels and their complementary color pixels from the information that is used in the determination.

5. The image processing apparatus according to claim 2, wherein, with respect to the color shift expected area, when the number of detected chromatic pixels falls below a threshold value that is determined based on the number of black pixels, the color/monochrome determining unit excludes the detected chromatic pixels and their complementary color pixels from the information that is used in the determination.

6. The image processing apparatus according to claim 2, wherein when the chromatic pixels are positioned adjacent to one side of the black pixel and their complementary color pixels are positioned adjacent to the other side in the color shift expected area, the color/monochrome determining unit excludes the detected chromatic pixels and their complementary color pixels from the information that is used in the determination.

7. The image processing apparatus according to claim 2, wherein
the color/monochrome determining unit can select:
a first mode in which the chromatic pixels and their complementary color pixels detected in the color shift expected area are excluded from the information that is used in the determination in which the original document of the image data is determined as color or monochrome; or
a second mode in which the chromatic pixels and their complementary color pixels detected in the color shift expected area are included in the information that is used in the determination.

8. The image processing apparatus according to claim 1, wherein
the input unit can input test chart image data that is obtained by scanning a test chart original document through the sensor; and
the color/monochrome determining unit can automatically set the color shift expected area by analyzing the test chart image data.

9. The image processing apparatus according to claim 1, wherein the color/monochrome determining unit can change the color shift expected area in accordance with a medium type of the original document.

10. An original document scanning apparatus comprising:
an original document scanning unit arranged to scan an original document through a Charge Coupled Device sensor including a plurality of lines that can scan color documents;
an Auto Document Feeder; and
an image processing apparatus; wherein the image processing apparatus includes:
an input unit arranged to input image data that is obtained by scanning the original document through the sensor having the plurality of lines that can scan the color documents; and
a color/monochrome determining unit arranged to determine whether the original document or a portion of the original document is color or monochrome based on the image data input through the input unit;
the color/monochrome determining unit includes a hue determining unit arranged to determine a hue of each pixel that is included in the image data; and
as a result of the determination made by the hue determining unit, when chromatic pixels and their complementary color pixels are detected in a color shift expected area, which is a specified image area of the image data, the color/monochrome determining unit makes the color/monochrome determination with respect to the color shift expected area under conditions differing from conditions of other image areas.

11. The original document scanning apparatus according to claim 10, wherein
the color documents can be scanned with a flatbed;
when the original document is transported and scanned through the Auto Document Feeder, the color/monochrome determining unit of the image processing apparatus excludes the chromatic pixels and their complementary color pixels detected in the color shift expected area from information that is used in the color/monochrome determination of the original document; and
when the original document is scanned in the flatbed method, the color/monochrome determining unit includes the chromatic pixels and their complementary color pixels detected in the color shift expected area in the information that is used in the color/monochrome determination of the original document.

12. The original document scanning apparatus according to claim 10, wherein
the color document can be scanned in the flatbed method; and
the image processing apparatus can store the different color shift expected areas and select the color shift expected area that is used when the original document is transported and scanned through the Auto Document Feeder or the color shift expected area that is used when the original document is scanned in the flatbed method.

13. A color/monochrome determining method comprising:
a step of determining whether an original document or a portion of the original document is color or monochrome based on image data that is obtained by scanning the original document through a sensor including a plurality of lines that can scan color documents; wherein
with respect to a color shift expected area, which is a specified image area of the image data, when chromatic pixels having opposite hues are detected on both sides of a black pixel, the determination is made with respect to the color shift expected area under conditions differing from conditions of other areas in the color/monochrome determining step.

14. The color/monochrome determining method according to claim 13, wherein the chromatic pixels and their complementary color pixels detected in the color shift expected area are excluded from information that is used in the color/monochrome determination in the color/monochrome determining step.

15. The color/monochrome determining method according to claim 14, wherein
the color/monochrome determining step further includes:
a hue determining step that determines which hue area, which is set by dividing a color space into a plurality of areas in hue directions, the detected chromatic pixel belongs to;
an each-hue-area counting step that counts, with respect to each hue area, the number of pixels that have been determined to belong to the corresponding hue area;
an each-hue-area-color determining step that compares, with respect to each hue area, the counted number of pixels with a prescribed threshold value, and then determines that there is a color of the corresponding hue area when the counted number of pixels exceeds the threshold value; and
a determining step that determines whether the original document or a portion of the original document of the image data is color or monochrome;
in the each-hue-area counting step and the each-hue-area-color determining step, the number of pixels is counted and the determination regarding the existence of the color is made with respect to each image area, which is set by dividing the image data into a plurality of areas; and
in the determining step, with respect to the image area that is included in the color shift expected area, when the each-hue-area-color determining step determines that there is a color in at least two hue areas, and further, only when each hue area is a pair of hue areas that are in a complementary-color relationship with each other, each pixel that is in the image area and that has been determined to belong to any of the pair of hue areas is excluded from the information that is used in the color/monochrome determination.

16. The color/monochrome determining method according to claim 14, wherein in the color/monochrome determining step, when a difference between the number of chromatic pixels and the number of their complementary color pixels detected in the color shift expected area falls below a prescribed value, the detected chromatic pixels and their complementary color pixels are excluded from the information that is used in the determination.

17. The color/monochrome determining method according to claim 14, wherein in the color/monochrome determining step, when the number of chromatic pixels detected in the color shift expected area falls below a threshold value that is determined based on the number of black pixels, the detected chromatic pixels and their complementary color pixels are excluded from the information that is used in the determination.

18. The color/monochrome determining method according to claim 14, wherein in the color/monochrome determining step, when the chromatic pixels are positioned adjacent to one side of the black pixel, and their complementary color pixels are positioned adjacent to the other side in the color shift expected area, the detected chromatic pixels and their complementary color pixels are excluded from the information that is used in the determination.

19. The color/monochrome determining method according to claim 14, wherein
the color/monochrome determining step can select:
a first mode in which the chromatic pixels and their complementary color pixels detected in the color shift expected area are excluded from the information that is used in the determination in which the original document of the image data is determined as color or monochrome; or
a second mode in which the chromatic pixels and their complementary color pixels detected in the color shift expected area are included in the information that is used in the determination.

20. The color/monochrome determining method according to claim 13, wherein in the color/monochrome determining step, test chart image data obtained by scanning a test chart original document through the sensor can be input, and by analyzing the test chart image data, the color shift expected area is automatically set.
